(19) United States
(12) Patent Application Publication
(10) Pub. No.: US 2024/0005100 A1
(43) Pub. Date: Jan. 4, 2024

(54) Control Unit to Map at least One Element in a Plurality of Documents and a Method therefor

(71) Applicants: Robert Bosch GmbH, Stuttgart (DE); Bosch Global Software Technologies Private Limited, Bangalore (IN)

(72) Inventors: Gupta Rishabh, Uttar Pradesh (IN); Manojit Chakraborty, West Bengal (IN)

(21) Appl. No.: 18/339,741

(22) Filed: Jun. 22, 2023

(30) Foreign Application Priority Data
Jun. 30, 2022 (IN) 2022 4103 7766

(51) Int. Cl. G06F 40/30; G06F 40/289; G06F 40/205

(52) U.S. Cl. CPC G06F 40/30; G06F 40/289; G06F 40/205

(57) ABSTRACT

A control unit to map at least one element present in plurality of documents (i.e., a first document and a second document) is disclosed. The control unit identifies the at least one element in the plurality of documents and identifies at least one semantic bridge between the first document and the second document using string-based similarities. The control unit generates a corresponding taxonomy graph and a graph embedding for the at least one element of the first document and the second document. The control unit correlates the generated corresponding graph embeddings of the at least one element of the first document and the second document. The control unit maps the at least one element of the first document to the at least one element of the second document using a vector function.

This application claims priority under 35 U.S.C. § 119 to application no. IN 2022 4103 7766, filed on Jun. 30, 2022 in India, the disclosure of which is incorporated herein by reference in its entirety.

The disclosure is related to a control unit to map at least one element in plurality of documents and a method thereof.

### BACKGROUND

Due to several regulations and sometimes corporate mergers, a source organization (such as OEMs) shares the Instructional documents such as repair manuals, user manuals, etc., with the target organization (such as non-OEMs). To understand these shared documents, the target organization needs to map the source taxonomy to the target taxonomy which is a tedious task and involvement of cost. The present disclosure provides solution to the above stated problem with a cost-effective solution.

A US patent application 8527262 discloses a Systems and methods for automatic semantic role labeling of high morphological text for natural language processing applications. Systems and methods are provided for automated semantic role labeling for languages having complex morphology. In one aspect, a method for processing natural language text includes receiving as input a natural language text sentence comprising a sequence of white-space delimited words including inflicted words that are formed of morphemes including a stem and one or more affixes, identifying a target verb as a stem of an inflicted word in the text sentence, grouping morphemes from one or more inflicted words with the same syntactic role into constituents, and predicting a semantic role of a constituent for the target verb.

### BRIEF DESCRIPTION OF THE DRAWINGS

An embodiment of the disclosure is described with reference to the following accompanying drawing.

FIG. 1 illustrates a control unit to map at least one element in plurality of documents according to one embodiment of the disclosure: and

FIG. 2 illustrates a flow chart of a method of mapping at least one element in plurality of documents according to the present disclosure.

### DETAILED DESCRIPTION

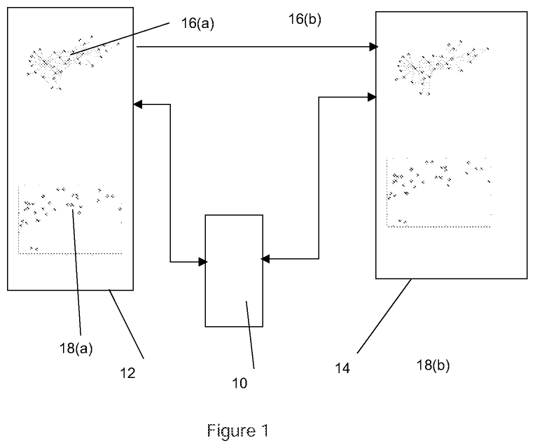

FIG. 1 illustrates a control unit to map at least one element present in plurality of documents according to one embodiment of the disclosure. The plurality of documents (12,14) comprises a first document 12 and a second document 14. The control unit 10 identifies the at least one element in the plurality 5 of documents (12,14). The control unit 10 identifies at least one semantic bridge between the first document 12 and the second document 14 using string-based similarities. The control unit 10 generates a corresponding taxonomy graph and a graph embedding for the at least one element of the first document 12 and the at least one element of the second document 14. The control unit 10 correlates the generated corresponding graph embeddings of the at least one element of the first document 12 and the second document 14. The control unit 10 maps the at least one element of the first document 12 to the at least one element of the second document 14 using a vector function.

Further the mapping of the elements in the plurality of documents are explained in detail. The plurality of documents (12,14) is chosen from a group of documents comprising manuals, contracts, legal documents and the like. However, it is to be understood that the type of document is not restricted to above, but can be of any other document that is known to person skilled in the art. According to one embodiment of the disclosure, the plurality of documents (12, 14) can be more than two documents. The control unit 10 is chosen from a group of control units comprising a microprocessor, a microcontroller, a digital circuit and an integrated chip and the like. The at least one element is referred as taxonomy elements at some places in this document. It is to be noted that the at least one element and taxonomy element and nodes are considered as same. The control unit 10 identifies elements in both first document 12 and the second document 14 separately and maps with each other in a common space.

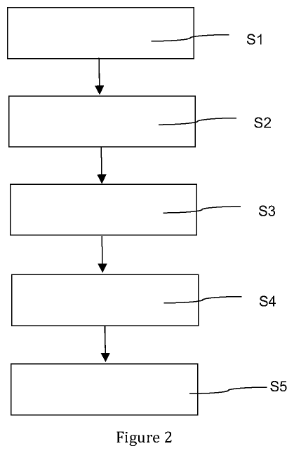

FIG. 2 illustrates a method of mapping at least one element in plurality of documents according to present disclosure. The method involves following steps. In step S1, at least one element in the plurality of documents (12,14) is identified. In step S2, at least one semantic bridge between the first document 12 and the second document 14 using string-based similarities is identified. In step S3, a corresponding taxonomy graph (16(a, b)) and a graph embedding 18(a, b) for the at least one element of the first document 12 and the at least one element of the second document 14 are generated. In step S4, the generated corresponding graph embeddings 18(a, b) of the at least one element of the first document 12 and the second document 14 are correlated. In step S5, the at least one element of the first document 5 12 is mapped to the at least one element of the second document 14 using a vector function.

The method is explained in detail. The mapping of elements in multiple documents is done by a control unit 10 according to one embodiment of the disclosure. The control unit 10 identifies at least one element in the plurality of documents (12, 14). For instance, the plurality of documents is the first document 12 and the second document 14. The control unit 10 identifies the elements in these two documents (12,14) separately. For ease of understanding, we are explaining the process in the first document 12. The same will be applicable to the second document 15 14. The control unit 10 considers multiple phrases in the first document 12 and creates a dependency parse tree corresponding to each of the considered phrases.

After the creation of the dependency parse tree, the control unit 10 identifies the tags for each of the consider phrase i.e., for example if the considered phrase is “disconnect the electric connection for the lock” then the tags to those phrases will be finding which is verb, adjective and noun and the like in that phrase. The identified tags are different types of English grammar forms in a sentence. The control unit 10 identifies the noun words as nodes/elements and constructs a graph using those nodes/elements and generates plurality of edges that are (unweighted and undirected) between those nodes/elements. The graph is formed between the nodes/elements using these edges.

The control unit 10 then ranks those identified nodes using a link analysis function and selects the nodes/elements that have the rank above a predefined threshold value. For example, if the identified nouns in the above phrase are “connection” and “lock”. Each is given a rank using the link analysis function. The ranks assigned are say 2 and 5 and the threshold is 3, then the control unit 10 considers the node/element which has the higher rank than the predefined threshold (which is 3) and the “lock” node/element is selected.

The control unit 10 identifies more than one node/element in the first document 12 and the above-disclosed process is performed for the 5 second document 14 for identifying the nodes/elements. Once the elements or nodes (it is to be noted that both refers to same thing) are identified in both the documents (12,14). The control unit 10 upon identifying and ranking the elements in the first and the second documents (12,14) activates the process of mapping those elements in those documents (12,14).

The mapping process involves the following steps. The control unit 10 identifies plurality of semantic bridges (which are the prepositions in the English grammar) that are present between the first document 12 identified elements and the second document 14 identified elements. The control unit 10 identifies these semantic bridges using string-based similarities. The semantic bridges are pairs of component names present in the plurality of the documents (12,14) which has stringbased similarities. For instance, “Rear left tire” in first document 12 is matched with the “Rear left tire”. In this scenario, it is of same string types. In another instance, “Airbag” in first document 12 is matched with “Airbags” in the second document 14. In this scenario, the string is in the plural form. Yet in another scenario, “Windscreen wiper motor “in the first document 12 will be matched with “Screen wiper motor” of the second document 14. The control unit 10 then generates the taxonomy graphs (16(a, b)) for both the first and the second documents (12,14) using the elements. Each of the documents (both first and the second documents (12,14) each will have a taxonomy graph (16(a, b)) generated using those elements).

The control unit 10 then generates the graph embeddings 18(a, b) corresponding to the first document 12 and the second document 14. The graphs 16(a, b) generated have elements as nodes. The graph 16(a)/16(b) is taken as an input to a graph embedding model to generate embedding vector 18(a)/18(b) for each element/node of the graph. The graph embedding is a method/algorithm used to transform nodes/elements, edges, and their features into vector space. The control unit 10 uses a graph convolutional network (GCN), Node2Vec methods for generating the embeddings 18(a, b) related to the first document elements and the second document elements.

The control unit 10 projects the first graph embeddings and the second graph embeddings using a linear transformation function in a common space 5 and correlates the generated embeddings with each other. Then the control unit 10 matches/maps the first identified element to a second identified element using a vector function when correlated. The identified element in the first document is matched with same/similar element in the second element or to the closest element in the second document based on the vector value.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A control unit to map at least one element present in a plurality of documents, wherein said plurality of documents includes a first document and a second document, said control unit being configured to:
identify said at least one element in said plurality of documents;
identify at least one semantic bridge between said first document and said second document using string based similarities;
generate a corresponding taxonomy graph and a graph embedding for said at least one element of said first document and said at least one element of said second document;
correlate said generated corresponding graph embeddings of said at least one element of said first document and said second document; and
map said at least one element of said first document to said at least one element of said second document using a vector function.

2. The control unit as claimed in claim 1, wherein said at least one element is identified in said plurality of documents by creating a corresponding dependency parse tree structure for each of a considered phrase in said plurality of documents.

3. The control unit as claimed in claim 2, wherein said control unit is further configured to identify tags in each of said considered phrase and detect nodes/elements in said identified tags.

4. The control unit as claimed in claim 3, wherein said control unit is further configured to create a graph between said detected nodes/elements using undirected and unidentified edges.

5. The control unit as claimed in claim 4, wherein said control unit is further configured to rank said nodes/elements using a link analysis function and to select said nodes with said rank above a threshold value.

6. The control unit as claimed in claim 5, wherein said control unit is further configured to:
refer said selected nodes/elements as said at least one element, and
consider for mapping between said plurality of documents.

7. The control unit as claimed in claim 1, wherein said plurality of documents are chosen from a group of documents including manuals, legal documents, contracts.

8. A method of mapping at least one element present in a plurality of documents by a control unit, wherein said plurality of documents includes a first document and a second document, said method comprising:
identifying said at least one element in said plurality of documents;
identifying at least one semantic bridge between said first document and said second document using string based similarities;
generating a corresponding taxonomy graph and a graph embedding for said at least one element of said first document and said at least one element of said second document;
correlating said generated corresponding graph embeddings of said at least one element of said first document and said second document; and
mapping said at least one element of said first document to said at least one element of said second document using a vector function.

9. The method as claimed in claim 8, wherein said at least one element in said plurality of documents are identified by a dependency parse tree and a vector function.
